(19) United States
(12) Patent Application Publication
(10) Pub. No.: US 2017/0192531 A1
(43) Pub. Date: Jul. 6, 2017

(54) PHANTOM DIALS FOR INSTRUMENT CLUSTER

(71) Applicant: Continental Automotive Systems, Inc., Auburn Hills, MI (US)

(72) Inventors: Jose Arturo Sanchez Lopez, Guadalajara (MX); Maria Nohemi Bravo Solis, Tlajomulco de Zuniga (MX); Diego Trujillo De Alba, Guadalajara (MX)

(21) Appl. No.: 15/003,120

(22) Filed: Jan. 21, 2016

Related U.S. Application Data
(60) Provisional application No. 62/273,239, filed on Dec. 30, 2015.

(51) Int. Cl. G06F 3/0362; B60K 35/00; G02F 1/163

(52) U.S. Cl. CPC G06F 3/0362; G02F 1/163; B60K 35/00; B60K 2350/206; B60K 2350/2039; B60K 2350/352

(57) ABSTRACT

An instrument cluster assembly includes a dial face having a plurality of first indicia disposed thereon. A pointer is configured to selectively point to the plurality of first indicia disposed on the dial face. A selectable light blocker is disposed over the dial face and the pointer. The selectable light blocker is configured to be reconfigured between a see-through mode and a blocking mode. In the see-through mode, a user can see the dial face and the pointer through the selectable light blocker. In the blocking mode, the user is substantially blocked from seeing the dial face and the pointer. A see-through digital electronic display is disposed over the dial face. The selectable light blocker is disposed between the pointer and the see-through digital electronic display. The see-through digital electronic display is configured to electronically generate a plurality of second indicia.

### FIELD

This invention generally relates to an instrument cluster display. More particularly this invention relates to an instrument cluster display for an automobile that includes an analog and a digital display.

### BACKGROUND

An instrument cluster for a motor vehicle typically includes a dial with a scale indicative of a vehicle performance or operational parameter. A pointer is rotated about a central axis to point to a specific indicator on the dial to communicate the current state of the measured parameter. The basic configuration of an instrument cluster is modified to provide a desired aesthetic appearance to the interior of a vehicle.

In recent years, an increasing amount of information has become available that may be conveyed to a driver. Accordingly, additional instrument clusters and/or displays may be used to show such information. Displays, moreover, can be configurable to show different sets of information.

Each of the instrument clusters and displays occupies a certain amount of finite space on an instrument panel. Moreover, the reconfigurability and complexity of the digital display systems may be undesirable to certain drivers, particularly those who have become accustomed to looking at the analog instrument clusters with pointers described above. Drivers who have these preferences may prefer not to view digital displays, while other tech-savvy drivers may prefer the digital displays over the older analog-type displays.

Accordingly, it is desirable to design and develop an instrument cluster assembly that is customizable to meet the divergent desires of various drivers.

### SUMMARY

A selectable instrument cluster assembly is provided that includes an analog dial face and pointer, along with a see-through digital display provided over the dial face and pointer. A selectable light blocking element is disposed between the digital display and the analog dial face. A user can select whether he or she views the digital display or the analog dial face by lightening or darkening, or increasing/decreasing the reflectivity of, the selectable light blocking element.

In one form, which may be combined with or separate from the other forms described herein, an instrument cluster assembly is provided that includes a dial face including a plurality of first indicia disposed thereon. A pointer rotatable about a central axis is configured to selectively point to the plurality of first indicia disposed on the dial face. A selectable light blocker is disposed over the dial face and the pointer. The pointer is disposed between the dial face and the selectable light blocker. The selectable light blocker is configured to be reconfigured between a see-through mode and a blocking mode. In the see-through mode, a user can see the dial face and the pointer through the selectable light blocker. In the blocking mode, the user is substantially blocked from seeing the dial face and the pointer. A see-through digital electronic display is disposed over the dial face, the pointer, and the selectable light blocker. The selectable light blocker is disposed between the dial face and the see-through digital electronic display. The see-through digital electronic display is configured to electronically generate a plurality of second indicia.

In another form, which may be combined with or separate from the other forms described herein, an instrument cluster assembly is provided that includes a dial face having a plurality of first indicia disposed thereon and a pointer configured to selectively point to the plurality of first indicia disposed on the dial face. A selectable light blocker is disposed over the dial face and the pointer. The selectable light blocker is configured to be reconfigured between a see-through mode and a blocking mode. In the see-through mode, a user can see the dial face and the pointer through the selectable light blocker, and in the blocking mode, the user is substantially blocked from seeing the dial face and the pointer. A see-through digital electronic display is disposed over the dial face. The selectable light blocker is disposed between the pointer and the see-through digital electronic display. The see-through digital electronic display is configured to electronically generate a plurality of second indicia. The see-through digital electronic display can be a liquid crystal display (LCD), an organic light-emitting diode (OLED) display, a thin film transistor (TFT) display, or a picture generation unit (PGU) having a projector and a lens, by way of example.

In yet another form, which may be combined with or separate from the other forms described herein, a selectable instrument cluster system for a motor vehicle is provided. The system includes a dial face including a plurality of first indicia disposed thereon. A pointer is configured to selectively point to the plurality of indicia on the dial face. A selectable light blocker is disposed over the dial face and the pointer. A see-through digital electronic display is disposed over the dial face, the pointer, and the selectable light blocker. The selectable light blocker is disposed between the dial face and the see-through digital electronic display. The see-through digital electronic display is configured to selectively electronically generate a plurality of second indicia. The system is configured to operate in an analog mode and a digital mode, and the user may select between the analog mode and the digital mode. In the analog mode, the system causes the selectable light blocker to appear see-through so that a user can see the dial face and pointer through the selectable light blocker. In the digital mode, the system causes the selectable light blocker to appear substantially opaque so that the user is substantially blocked from seeing the dial face and the pointer. In addition, the see-through digital electronic display is configured to generate the plurality of second indicia in the digital mode.

Accordingly, the example instrument cluster assembly and system provides for multiple display systems that fit in a compact space and may be selectable by the user based on preference.

These and other features of the present disclosure can be best understood from the following specification and drawings, the following of which is a brief description.

### BRIEF DESCRIPTION OF THE DRAWINGS

FIG. 1A is an exploded view of an example instrument cluster assembly, in accordance with the principles of the present disclosure;

FIG. 1B is a side cross-sectional view of the instrument cluster assembly of FIG. 1A, according to the principles of the present disclosure;

FIG. 1C is a front view of the instrument cluster assembly of FIGS. 1A-1B in a first mode, in accordance with the principles of the present disclosure;

FIG. 1D is a front view of the instrument cluster assembly of FIGS. 1A-1C in a second mode, according to the principles of the present disclosure;

FIG. 2A is an exploded view of another example instrument cluster assembly, in accordance with the principles of the present disclosure;

FIG. 2B is a side cross-sectional view of the instrument cluster assembly of FIG. 2A, according to the principles of the present disclosure; and

FIG. 3 is an exploded view of yet another example instrument cluster assembly, in accordance with the principles of the present disclosure.

### DETAILED DESCRIPTION

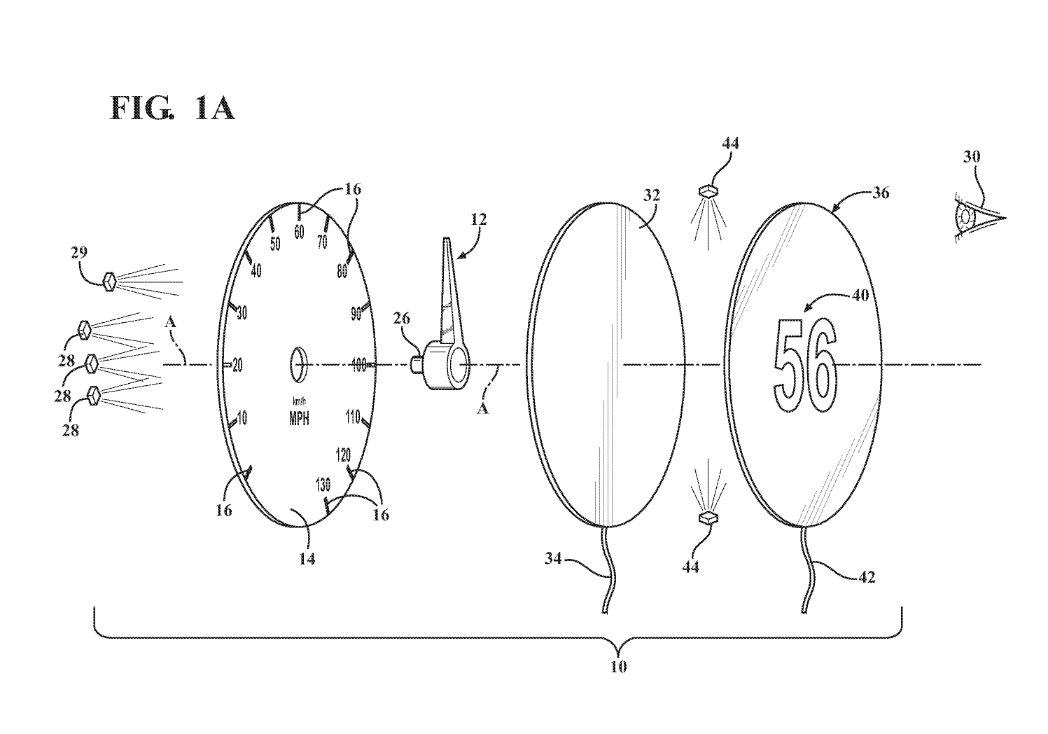

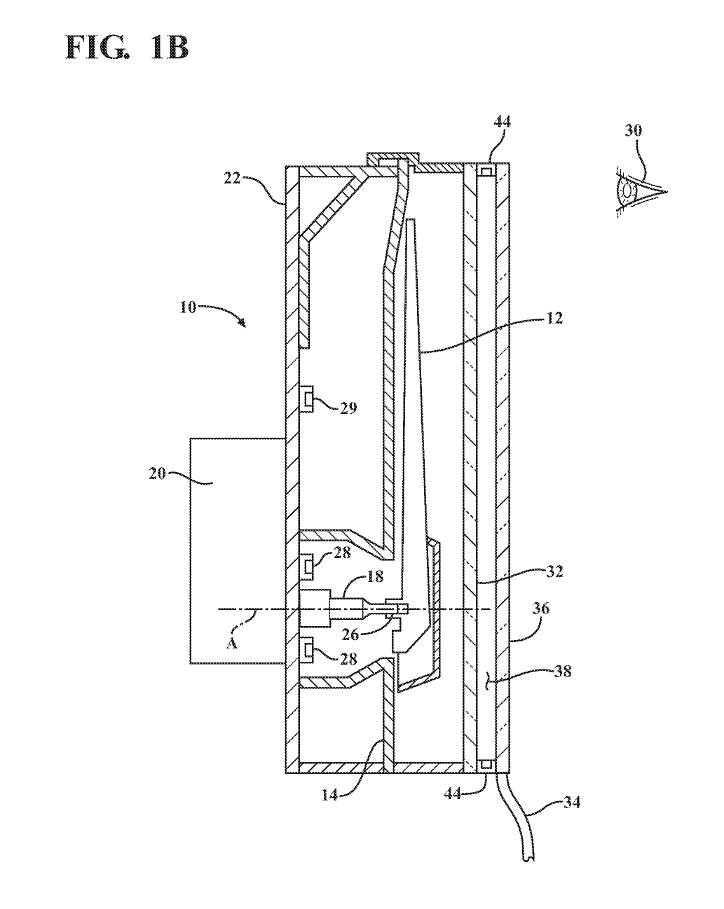

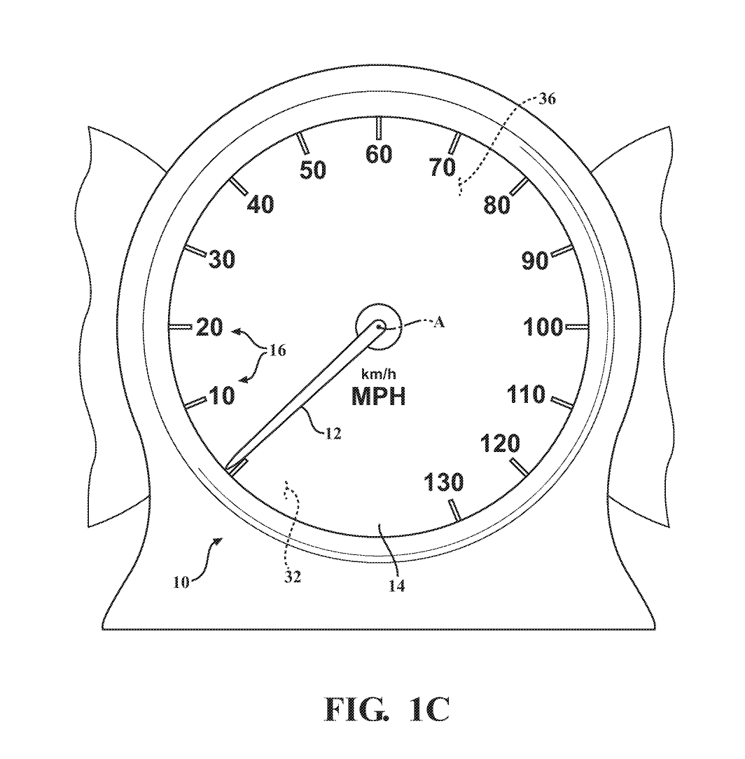

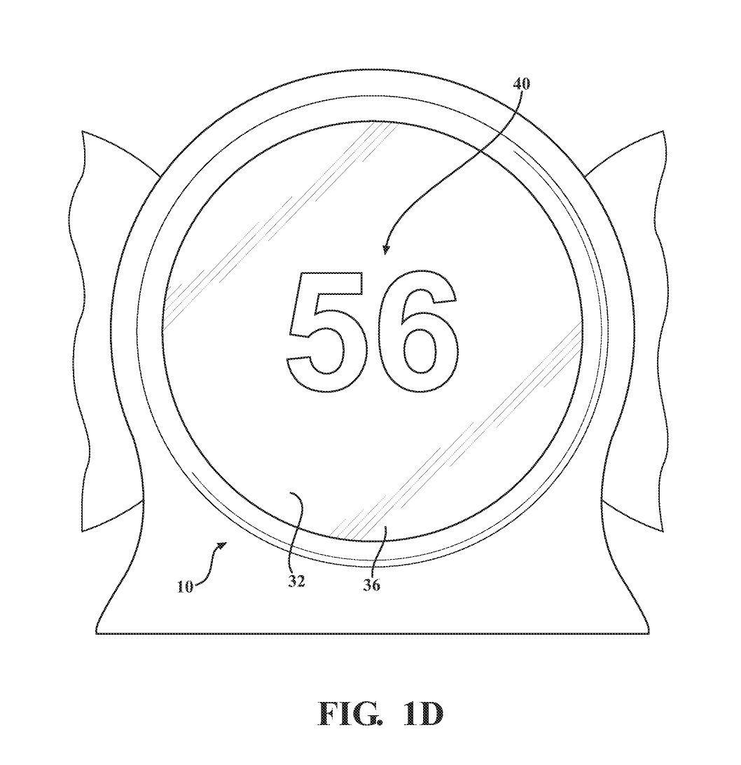

Referring to FIGS. 1A-1B, an example instrument cluster assembly is illustrated and generally designated at 10. The instrument cluster assembly 10 may be used in a motor vehicle, by way of example. Information given by the instrument cluster assembly 10 may include, by way of example, tachometer information, vehicle speed information, fuel level information, engine temperature, or any other information that is desired to communicate to the driver of the vehicle.

The instrument cluster assembly 10 includes a pointer 12 (which could be one piece or a pointer assembly) that is configured to rotate about an axis of rotation A, wherein the axis of rotation A extends through an appliqué surface or dial face 14 to indicate a specific operating parameter. Several indicia 16, such as speed values or fuel level markers, may be located on the dial face 14. The indicia 16 are disposed in a generally circular pattern about the axis of rotation A. In this example, the indicia 16 are disposed over a portion of an invisible circle that surrounds the axis of rotation A, but it should be understood that the indicia 16 may be disposed around more of the axis of rotation A, such as in an entire circle around the axis of rotation A, or in another pattern that is not centered around the axis of rotation A. Thus, the pointer 12 is rotatable about the rotational axis A and configured to selectively point to the plurality of indicia 16 disposed on the dial face 14.

The pointer 12 is configured to rotate or move with respect to the dial face 14, about the axis A. For example, the pointer 12 may be mounted to a shaft 18 that is connected to and driven by a stepper motor 20. The stepper motor 20 may be mounted to or connected to a printed circuit board 22. The stepper motor 20 is configured to rotate the shaft 18 that is coaxial with the axis of rotation A. As the shaft 18 is fixedly connected to a stem 26 of the pointer 12, the pointer 12 rotates with the shaft 18. Thus, the pointer 12 is supported for rotation about the axis of rotation A. It should be understood, however, that that pointer 12 could have other configurations that do not require that it rotate about an axis of rotation A.

The pointer 12 may be a light guide or any other type of pointer 12. For example, the pointer 12 may be formed of a light conducting material that is configured to receive light rays and conduct the light rays that originate from one or more light sources 28. The light sources 28 are light-emitting diode (LED) packages, in this example. The LEDs 28 are disposed directly on the PCB 22, in this example. The LEDs 28 are disposed in a circular pattern around the axis of rotation A and are offset from the axis of rotation A; however, it should be understood that the LEDs 28 could alternatively be disposed along the axis of rotation A or disposed in any other suitable manner. The pointer 12 is thus illuminated by the light sources 28. The example pointer 12 may be provided with features that reflect the light to provide for the substantially uniform distribution and propagation of light along the entire pointer 12.

Another light source 29 may be used to illuminate the indicia 16 on the dial face 14, by way of example. The dial face 14 may be disposed between the pointer 12 and the light sources 28. The dial face 14 may be opaque or translucent, or substantially opaque, by way of example. In some variations, a dead front lens may be used.

A selectable light blocker 32 is disposed over the dial face 14 and the pointer 12. In the example of FIGS. 1A-1B, the pointer 12 is disposed between the dial face 14 and the selectable light blocker 32. The selectable light blocker 32 may be formed of electro-chromatic materials, by way of example, that allow the selectable light blocker 32 to be lightened and darkened selectively. For example, a current or voltage may be applied to the selectable light blocker 32 through electrical leads 34, and when the current is applied, the light blocker 32 may appear to be darkened until it appears substantially opaque.

The electro-chromatic characteristics of the light blocker 32 may allow the tint or level of translucency of the light blocker 32 to be adjusted electronically. Adjusting the applied voltage of the light blocker 32 may decrease the light transmission of the light blocker 32 and/or increase the light reflection by the light blocker 32. This changes the visibility through the light blocker 32, as viewed by the occupant 30. A controller (not shown) may apply a voltage to the light blocker 32 to affect the amount of light that is reflected by and/or transmitted through the light blocker 32. In some examples, a voltage may be applied by the controller to increase the reflection characteristics of the light blocker 32. The applied voltage may also or alternatively decrease the light transmission through the light blocker 32. Such increase in light reflection and/or decrease in light transmission may have the visual effect of adding a “tint” to or darkening the light blocker 32, or to provide a degree of opacity to the light blocker 32 so that the light blocker 32 no longer appears as transparent. A different voltage or no voltage may be applied to the light blocker 32 to cause the light blocker 32 to be substantially transparent, reflect less, and/or allow more light transmission through the light blocker 32.

For example, in some variations, when no voltage is applied, the light blocker 32 may appear more transparent than when a voltage level is applied because more light is transmitted through the light blocker 32 and/or less light is reflected by the light blocker 32. In some examples, the light blocker 32 may be completely transparent or substantially transparent at certain or no voltage levels. In this example, the greater the voltage level that is applied, the darker that the light blocker 32 will appear. The applied voltage may fall and rise in a constant manner; in other examples, the applied voltage may be pulse-width-modulated.

As explained above, the selectable light blocker 32 may be configured to be lightened (or have increased light transmission/decreased light reflection) in a see-through mode, or an analog mode, and darkened (or having decreased light transmission/increased light reflection) in a blocking mode, or a digital mode. In the see-through mode (or the analog mode), the light blocker 32 is lightened to be transparent or translucent (for example, by applying little or no voltage to it) and a user can see the dial face 14 and the pointer 12 through the selectable light blocker 32. On the other hand, in the blocking mode (or the digital mode), the user is substantially blocked from seeing the dial face 14 and the pointer 12. For example, in the blocking mode, a voltage may be applied to the light blocker 32 through leads 34 to “darken” the light blocker 32, making it appear substantially opaque, so that the pointer 12 and dial face 14 are not visible to the occupant 30. Thus, the selectable light blocker 32 is electronically activatable to change the selectable light blocker 32 between the see-through mode and the blocking mode.

A see-through digital electronic display 36 is disposed over the dial face 14, the pointer 12, and the selectable light blocker 32. A gap 38 may be fixed between the electronic display 36 and the light blocker 32, if desired; however, the gap 38 may be optional. The selectable light blocker 32 is disposed between the dial face 14 and the see-through digital electronic display 36.

The see-through digital electronic display 36 is configured to electronically generate a plurality of indicia 40. The indicia 40 may be reconfigurable, if desired. A lead 42 may extend from the digital electronic display 36 for controlling the indicia 40.

Referring to FIGS. 1C and 1D, which are front views of the instrument cluster assembly 10, the instrument cluster assembly is shown in the see-through mode, or the analog mode, in FIG. 1C. In the analog mode (or see-through mode), the analog components 12, 14 are visible to the driver. For example, the see-through digital electronic display 36 is selectively generating no indicia, so that the see-through digital electronic display 36 is substantially (or completely) transparent, or at least translucent. Furthermore, in the analog mode, the selectable light blocker 32 is in the see-through mode so that the light blocker 32 appears as substantially transparent, or at least see-through. Accordingly, the user views the dial face 14 and the analog pointer 12.

Referring to FIG. 1D, the instrument cluster assembly 10 is shown in the blocking mode, or the digital mode. In the digital mode, the selectable light blocker 32 appears substantially opaque. For example, a voltage may be applied to the selectable light blocker 32 to decrease the light transmissivity therethrough and increase light reflection by the light blocker 32. Therefore, the user is not able to see the pointer 12 and the dial face 14, which lay behind the light blocker 32. The light blocker 32 therefore provides a substantially opaque background for the digital display 36, which is see-through. The digital display 36 may then be “turned on” to show indicia 40 thereon.

Accordingly, a user may select whether to view the analog mode or the digital mode. Some users may prefer to view digital information, such as the indicia 40 of the digital display 36, while other users may prefer to view analog information, such as the pointer 12 and the dial face 14 having the indicia 16 disposed thereon. Both the pointer 12/dial face 14 combination and the digital display 36 can be used to convey the same information, such as speed information. Thus, the components of the instrument cluster assembly 10 may operate as a user selectable system for choosing how to view vehicle operating information.

The present configuration may also be useful for saving on space by allowing each of the scales to convey different information, rather than the same information as each other. For example, the pointer 12 and dial face 14 may be used to convey speed information, while the digital display 36 could be used to display other information that is not speed related. A vehicle controller or a user could toggle between the analog mode and the digital mode to view the various information.

A plurality of light sources 44 may be disposed between the see-through digital electronic display 36 and the selectable light blocker 32. The light sources 44 may provide back-lighting for the see-through digital electronic display 36. The light sources 44 may be LEDs, by way of example.

The see-through digital electronic display 36 may be a transparent liquid crystal display (LCD), back lit with LEDs 44, by way of example. However, it should be understood that the display 36 could be any other suitable type of electronic display, such as a thin film transistor (TFT) display, an organic light-emitting diode (OLED) display, or a picture generation unit (PGU) having a projector and a lens, such as the type used in head-up displays.

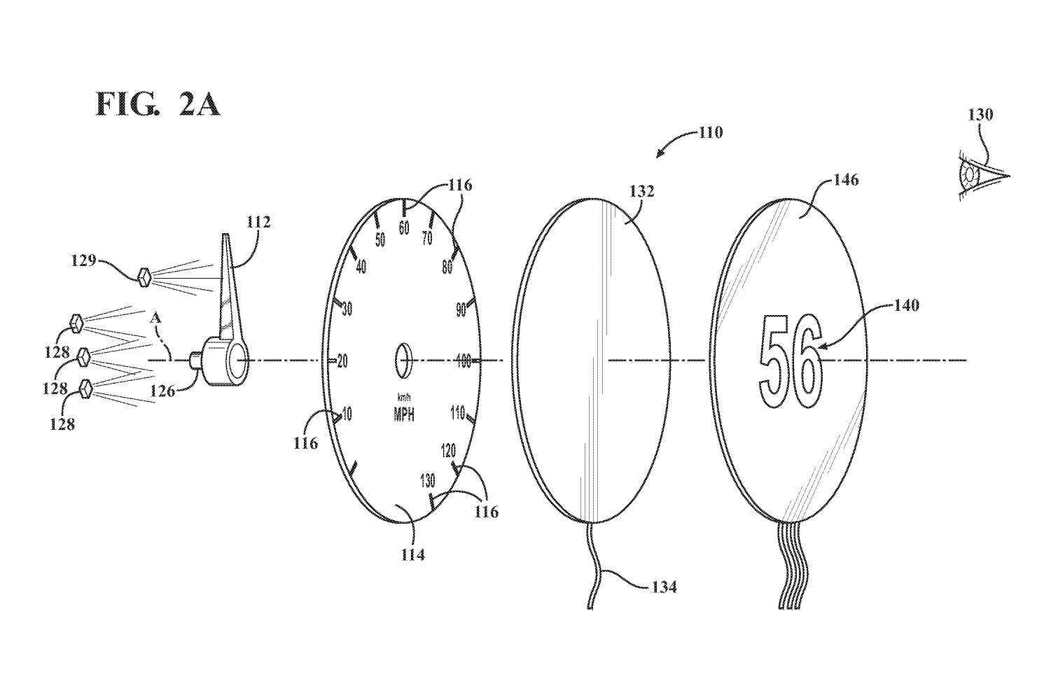

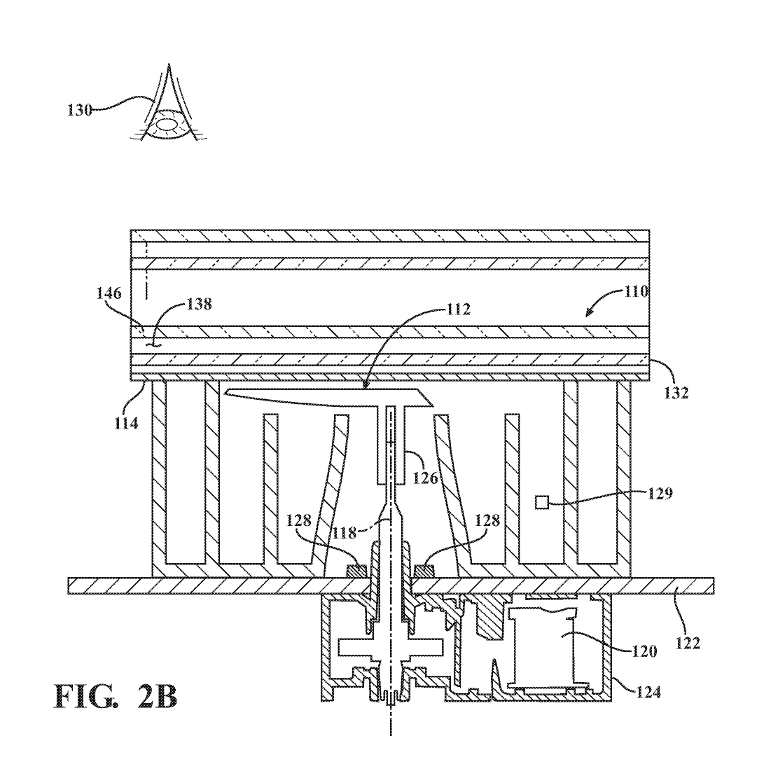

Referring now to FIGS. 2A-2B, another example instrument cluster assembly is illustrated and generally designated at 110. Like the instrument cluster 10 described above, the instrument cluster assembly 110 may be used in a motor vehicle. It should be understood that, to the extent that the example instrument cluster 110 is not described as being different from the instrument cluster 10 described above, the information given above also applies to the instrument cluster 110.

The instrument cluster assembly 110 includes a pointer 112 (which could be one piece or a pointer assembly) that is configured to rotate about an axis of rotation A, wherein the axis of rotation A extends through an appliqué surface or dial face 114 to indicate a specific operating parameter. In the alternative, the pointer 112 may move along a path that is not along a rotational axis. In addition, though the rotational axis A extends through dial face 114, the pointer 112 does not extend through the dial face 114 in this example. Instead, the pointer 112 is located behind the dial face 114 in a direction as viewed by an occupant 130, and the dial face 114 is located between the pointer 112 and the light blocker 132. Several indicia 116, such as those to indicate speed values or fuel level markers, may be disposed on the dial face 114.

The pointer 112 is configured to rotate or move with respect to the dial face 114, about the axis A. For example, the pointer 112 may be mounted to a shaft 118 that is connected to and driven by a stepper motor 120. The stepper motor 120 may be mounted to or connected to a printed circuit board 122 through a motor housing 124. The stepper motor 120 is configured to rotate the shaft 118 that is coaxial with the axis of rotation A. As the shaft 118 is fixedly connected to a stem 126 of the pointer 112, the pointer 112 rotates with the shaft 118. Thus, the pointer 112 is supported for rotation about the axis of rotation A. Similar to the assembly 10 described above, LEDs 128 conduct light to the pointer 112. Another light source 129 may be used to illuminate the indicia 116 on the dial face 114, by way of example. The pointer 112 may be disposed between the dial face 114 and the light sources 128.

The dial face 114 may be opaque or translucent, or substantially opaque, by way of example. In FIGS. 2A-2B, a dead front lens may be used. The pointer 112 illuminates the indicia 116 from under or behind the dial face 114.

A selectable light blocker 132 is disposed over the dial face 114 and the pointer 112. The selectable light blocker 132 may operate the same as the selectable the light blocker 32 described above, and such description is incorporated by reference in this section to apply to the selectable light blocker 132.

As explained above, the selectable light blocker 132 may be configured to appear lightened or see-through in a see-through mode, or an analog mode, and darkened or substantially opaque in a blocking mode, or a digital mode. In the see-through mode (or the analog mode), the light blocker 132 is “lightened” to appear transparent or translucent (for example, by applying little or no voltage to it) and a user can see the dial face 114 and the pointer 112 through the selectable light blocker 132. On the other hand, in the blocking mode (or the digital mode), the user is substantially blocked from seeing the dial face 114 and the pointer 112. For example, in the blocking mode, a voltage may be applied to the light blocker 132 through leads 134 to “darken” the light blocker 132, making it appear substantially opaque, so that the pointer 112 and dial face 114 are not visible to the occupant 130. Thus, the selectable light blocker 132 is electronically activatable to change the selectable light blocker 132 between the see-through mode and the blocking mode.

A see-through digital electronic display 146 is disposed over the dial face 114, the pointer 112, and the selectable light blocker 132. A gap 138 may be fixed between the electronic display 146 and the light blocker 132, if desired; however, the gap 138 may be optional. The selectable light blocker 132 is disposed between the dial face 114 and the see-through digital electronic display 146.

The see-through digital electronic display 146 is configured to electronically generate a plurality of indicia 140. The indicia 140 may be reconfigurable, if desired. A lead 142 may extend from the digital electronic display 146 for controlling the indicia 140. Similar to the example 10 described above, the instrument cluster assembly 110 may be selectively operated in see-through (analog) mode and blocking (digital mode).

In this example, the see-through digital electronic display 146 may be a substantially transparent organic light-emitting diode (OLED) display, which may not need to be back-lit with LEDs. However, it should be understood that the display 146 could be any other suitable type of electronic display, such as a TFT display, an LCD display, or a PGU, by way of example.

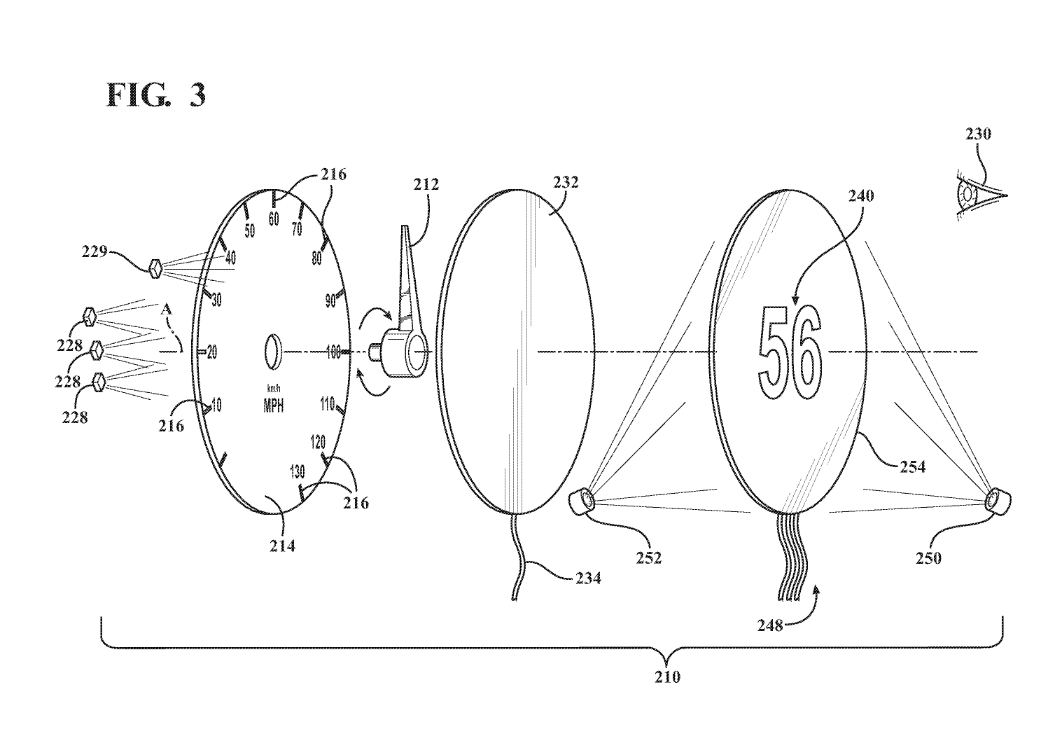

Referring now to FIG. 3, yet another example instrument cluster assembly is illustrated and generally designated at 210. Like the instrument cluster assemblies 10, 110 described above, the instrument cluster assembly 210 may be used in a motor vehicle. It should be understood that, to the extent that the example instrument cluster 210 is not described as being different from the instrument clusters 10, 110 described above, the information given above also applies to the instrument cluster 210.

The instrument cluster assembly 210 includes a pointer 212 (which could be one piece or a pointer assembly) that is configured to rotate about an axis of rotation A, wherein the axis of rotation A extends through an appliqué surface or dial face 214 to indicate a specific operating parameter. In the alternative, the pointer 212 can move along a path that is not along a rotational axis. The pointer 212 extends through the dial face 214 in this example, but it could alternatively be configured to operate behind the dial face 214 like the pointer 112 in FIGS. 2A-2B. Several indicia 216, such as speed values or fuel level markers, may be located on the dial face 214.

Similar to the assemblies 10, 110 described above, LEDs 228 conduct light to the pointer 212. Another light source 229 may be used to illuminate the indicia 216 on the dial face 214, by way of example. The dial face 214 may be disposed between the pointer 212 and the light sources 228.

A selectable light blocker 232 is disposed over the dial face 214 and the pointer 212. The selectable light blocker 232 may operate the same as selectable the light blocker 32 described above, and such description is incorporated by reference in this section to apply to the selectable light blocker 232.

As explained above, the selectable light blocker 232 may be configured to appear lightened in a see-through mode, or an analog mode, and darkened in a blocking mode, or a digital mode. In the see-through mode (or the analog mode), the light blocker 232 is “lightened” to appear transparent or translucent (for example, by applying little or no voltage to it) and a user can see the dial face 214 and the pointer 212 through the selectable light blocker 232. On the other hand, in the blocking mode (or the digital mode), the user is substantially blocked from seeing the dial face 214 and the pointer 212. For example, in the blocking mode, a voltage may be applied to the light blocker 232 through leads 234 to “darken” the light blocker 232, making it appear substantially opaque, so that the pointer 212 and dial face 214 are not visible to the occupant 230. Thus, the selectable light blocker 232 is electronically activatable to change the selectable light blocker 232 between the see-through mode and the blocking mode.

A see-through digital electronic display 248 is disposed over the dial face 214, the pointer 212, and the selectable light blocker 232. The selectable light blocker 232 is disposed between the dial face 214 and the see-through digital electronic display 248.

As before, the see-through digital electronic display 248 is configured to electronically generate a plurality of indicia 240, which may be reconfigurable, if desired. Similar to the example 10 described above, the instrument cluster assembly 210 may be selectively operated in see-through (analog) mode and blocking (digital mode).

In this example, the see-through digital electronic display 248 may comprise a picture generation unit (PGU) comprising at least one projector 250, 252 and a lens 254. In this example, a first projector 250 is disposed in front of the lens 254; and a second projector 252 is disposed behind the lens 254, between the lens 254 and the selectable light blocker 232. It should be understood, however, that only one of the projectors 250, 252 is needed. Each of the projectors 250, 252 may be used to project a light beam onto the lens 254 in such a way that the virtual image 240 is generated and viewable by the occupant 230, generally at a location offset from the lens 254 and farther out in front of the occupant 230.

Although the different examples have a specific component shown in the illustrations, embodiments of this disclosure are not limited to those particular combinations. It is possible to use some of the components or features from one of the examples in combination with features or components from another one of the examples. Furthermore, the foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. An instrument cluster assembly comprising:
a dial face including a plurality of first indicia disposed thereon;
a pointer rotatable about a central axis, the pointer configured to selectively point to the plurality of first indicia disposed on the dial face;
a selectable light blocker disposed over the dial face and the pointer, wherein the pointer is disposed between the dial face and the selectable light blocker, the selectable light blocker configured to be changed between a see-through mode and a blocking mode, wherein in the see-through mode, a user can see the dial face and the pointer through the selectable light blocker, and wherein in the blocking mode, the user is substantially blocked from seeing the dial face and the pointer; and
a see-through digital electronic display disposed over the dial face, the pointer, and the selectable light blocker, the selectable light blocker being disposed between the dial face and the see-through digital electronic display, the see-through digital electronic display configured to electronically generate a plurality of second indicia.

2. The instrument cluster assembly of claim 1, wherein the selectable light blocker is electronically activatable to change the selectable light blocker between the see-through mode and the blocking mode by causing the light blocker to appear substantially opaque in the blocking mode.

3. The instrument cluster assembly of claim 2, wherein the selectable light blocker comprises electro-chromatic material.

4. The instrument cluster assembly of claim 3, the selectable light blocker being electronically activatable to change the selectable light blocker between the see-through mode and the blocking mode by applying at least one of a current and a voltage to the selectable light blocker.

5. The instrument cluster assembly of claim 4, wherein the instrument cluster assembly is selectively reconfigurable to operate in first mode wherein the selectable light blocker is in the see-through mode and the dial face and the pointer are viewable by a user; the instrument cluster assembly being selectively reconfigurable to operate in a second mode wherein the selectable light blocker is in the blocking mode and the see-through digital electronic display generates a plurality of second indicia that are visible to the user in front of the light blocker in a direction as viewed by the user.

6. The instrument cluster assembly of claim 5, further comprising a plurality of light sources configured to provide back-lighting for the see-through digital electronic display.

7. The instrument cluster assembly of claim 6, the plurality of light sources comprising a plurality of light-emitting diodes.

8. The instrument cluster assembly of claim 7, the plurality of light sources being a plurality of first light sources, the instrument cluster assembly further comprising a plurality of second light sources configured to illuminate at least one of the pointer and the dial face.

9. The instrument cluster assembly of claim 8, the plurality of first light sources being located between the selectable light blocker and the see-through digital electronic display.

10. The instrument cluster assembly of claim 9, the dial face being disposed between the pointer and the plurality of second light sources.

11. The instrument cluster assembly of claim 10, wherein the see-through digital electronic display is a substantially transparent liquid crystal display (LCD).

12. The instrument cluster assembly of claim 10, wherein the see-through digital electronic display is one of a substantially transparent organic light-emitting diode (OLED) display, a picture generation unit (PGU) having a projector and a lens, and a thin film transistor (TFT) display.

13. An instrument cluster assembly comprising:
a dial face including a plurality of first indicia disposed thereon;
a pointer configured to selectively point to the plurality of first indicia disposed on the dial face;
a selectable light blocker disposed over the dial face and the pointer, the selectable light blocker configured to appear substantially see-through in a see-through mode and to appear substantially opaque in a blocking mode, wherein in the see-through mode, a user can see the dial face and the pointer through the selectable light blocker, and wherein in the blocking mode, the user is substantially blocked from seeing the dial face and the pointer; and
a see-through digital electronic display disposed over the dial face, the selectable light blocker being disposed between the pointer and the see-through digital electronic display, the see-through digital electronic display configured to electronically generate a plurality of second indicia, the see-through digital electronic display being one of a liquid crystal display (LCD), an organic light-emitting diode (OLED) display, a thin film transistor (TFT) display, and a picture generation unit (PGU) having a projector and a lens.

14. The instrument cluster assembly of claim 13, the selectable light blocker comprising electro-chromatic material, wherein the selectable light blocker is electronically activatable to change the selectable light blocker between the see-through mode and the blocking mode by applying a current to the selectable light blocker.

15. The instrument cluster assembly of claim 14, wherein the instrument cluster assembly is selectively reconfigurable to operate in first mode wherein the selectable light blocker is in the see-through mode and the dial face and pointer are viewable by a user; the instrument cluster assembly being selectively reconfigurable to operate in a second mode wherein the selectable light blocker is in the blocking mode and the see-through digital electronic display generates a plurality of second indicia that are visible to the user in front of the light blocker.

16. The instrument cluster assembly of claim 15, wherein the dial face comprises a dead-front lens material, the dial face being disposed between the pointer and the selectable light blocker, the instrument cluster assembly further comprising a plurality of light sources configured to provide back-lighting for the see-through digital electronic display, the plurality of light sources being disposed between the selectable light blocker and the see-through digital electronic display.

17. The instrument cluster assembly of claim 16, the plurality of light sources being a plurality of first light sources, the instrument cluster assembly further comprising a plurality of second light sources configured to illuminate at least one of the pointer and the dial face, the pointer being disposed between the dial face and the plurality of second light sources.

18. A selectable instrument cluster system for a motor vehicle, the system comprising:
a dial face including a plurality of first indicia disposed thereon;
a pointer configured to selectively point to the plurality of first indicia disposed on the dial face;
a selectable light blocker disposed over the dial face and the pointer; and
a see-through digital electronic display disposed over the dial face, the pointer, and the selectable light blocker, the selectable light blocker being disposed between the dial face and the see-through digital electronic display, the see-through digital electronic display configured to selectively electronically generate a plurality of second indicia, wherein
the system is configured to operate in an analog mode and a digital mode, wherein the user may select between the analog mode and the digital mode, wherein in the analog mode, the system causes the selectable light blocker to appear see-through so that a user can see the dial face and pointer through the selectable light blocker, and wherein in the digital mode, the system causes the selectable light blocker to appear substantially opaque so that the user is substantially blocked from seeing the dial face and the pointer, the see-through digital electronic display configured to generate the plurality of second indicia in the digital mode.

19. The system of claim 18, wherein the selectable light blocker comprises electro-chromatic material, the selectable light blocker being electronically activatable to cause the selectable light blocker to appear substantially opaque by applying a current to the selectable light blocker.

20. The system of claim 19, further comprising a plurality of light sources configured to provide back-lighting for the see-through digital electronic display, the plurality of light sources being disposed between the selectable light blocker and the see-through digital electronic display.
